(19) United States
(12) Patent Application Publication
(10) Pub. No.: US 2025/0068993 A1
(43) Pub. Date: Feb. 27, 2025

(54) SYSTEM AND METHOD FOR ELECTRONIC RESOURCE ACCESS MANAGEMENT

(71) Applicant: ROYAL BANK OF CANADA, Toronto (CA)

(72) Inventors: Signe HOEL, Montreal (CA); Amirreza OGHBAEE, New York, NY (US); Marat KHANDROS, Brooklyn, NY (US)

(73) Assignee: ROYAL BANK OF CANADA, Toronto, ON (CA)

(21) Appl. No.: 18/814,319

(22) Filed: Aug. 23, 2024

Related U.S. Application Data
(60) Provisional application No. 63/534,517, filed on Aug. 24, 2023.

(51) Int. Cl. G06Q 10/0631

(52) U.S. Cl. CPC G06Q 10/0631

(57) ABSTRACT

Systems and methods for managing electronic resource access are disclosed. An example computer system may include: a processor; and a non-transitory memory storing one or more sets of instructions that when executed by the processor, causes the system to: receive a user request for accessing or modifying an electronic resource; process the user request to obtain text data; apply feature engineering to the text data to output a feature matrix, the feature engineering comprising application of natural language processing to the text data; use a trained machine learning model to determine a probability score indicating a likelihood of incident occurrence as a result of the user request; and generate signals for displaying a decision granting or denying the user request based on the probability score.

### CROSS-REFERENCE TO RELATED APPLICATION

This application claims priority to and the benefit of U.S. provisional patent application No. 63/534,517 filed Aug. 24, 2023, the entirety of which is herein incorporated by reference.

### FIELD

Embodiments of the present disclosure relate to the field of electronic ctronl and management of electronic resources using machine learning.

### INTRODUCTION

A large organization has a variety of technology assets and electronic resources that are deployed across multiple systems and servers. Such electronic resources may include, for example, computing applications that are accessed and used by employees of the organization.

When a user requests to access or modify an electronic resource, automatic granting of the user request without due consideration may lead to unexpected incidents or failures of the one or more systems associated with the electronic resource.

### SUMMARY

In accordance with one aspect, there is provided a computer system for managing electronic resource access, the computer system comprising: a processor; and a non-transitory memory storing one or more sets of instructions that when executed by the processor, causes the system to: receive a user request for accessing or modifying an electronic resource; process the user request to obtain text data; apply feature engineering to the text data to output a feature matrix, the feature engineering comprising application of natural language processing to the text data; use a trained machine learning model to determine a probability score indicating a likelihood of incident occurrence as a result of the user request; and generate signals for displaying a decision granting or denying the user request based on the probability score.

In some embodiments, the instructions when executed by the processor further cause the system to: obtain one or more categorical fields and one or more numerical fields from the user request.

In some embodiments, the instructions when executed by the processor further cause the system to apply feature engineering to the data contained in the categorical fields and numerical fields to output the feature matrix.

In some embodiments, the natural language processing comprises processing the text data using a Term Frequency—Inverse Document Frequency technique to generate a word matrix for one or more words in the text data, the matrix comprising one or more elements.

In some embodiments, each of the one or more elements comprises a frequency score for a respective one of the one or more words.

In some embodiments, the instructions when executed by the processor further cause the system to: use the trained machine learning model to determine a second probability score indicating a likelihood of major incident occurrence as a result of the user request; and generate signals for displaying a decision granting or denying the user request based on the second probability score.

In some embodiments, the instructions when executed by the processor further cause the system to: use the probability score from the trained machine learning model as input to a second trained machine learning model; execute the second trained machine learning model to determine a second probability score indicating a likelihood of major incident occurrence as a result of the user request; and generate signals for displaying a decision granting or denying the user request based on the second probability score.

In some embodiments, the instructions when executed by the processor further cause the system to: use the probability score from the trained machine learning model as input to a decision tree model; and execute the decision tree model to determine the decision granting or denying the user request based on the probability score.

In accordance with another aspect, there is provided a computer-implemented method for managing electronic resource access, the method includes: receiving a user request for accessing or modifying an electronic resource; processing the user request to obtain text data; applying feature engineering to the text data to output a feature matrix, the feature engineering comprising application of natural language processing to the text data; using a trained machine learning model to determine a probability score indicating a likelihood of incident occurrence as a result of the user request; and generating signals for displaying a decision granting or denying the user request based on the probability score.

In some embodiments, the method may include obtaining one or more categorical fields and one or more numerical fields from the user request.

In some embodiments, the method may include: applying feature engineering to the data contained in the categorical fields and numerical fields to output the feature matrix.

In some embodiments, the natural language processing comprises processing the text data using a Term Frequency—Inverse Document Frequency technique to generate a word matrix for one or more words in the text data, the matrix comprising one or more elements.

In some embodiments, each of the one or more elements comprises a respective frequency score for a respective word of the one or more words.

In some embodiments, the method may include: using the trained machine learning model to determine a second probability score indicating a likelihood of major incident occurrence as a result of the user request; and generate signals for displaying a decision granting or denying the user request based on the second probability score.

In some embodiments, the major incident occurrence comprises an incident with one or more consequences meeting one or more predefined thresholds.

In some embodiments, the method may include: using the probability score from the trained machine learning model as input to a second trained machine learning model; executing the second trained machine learning model to determine a second probability score indicating a likelihood of major incident occurrence as a result of the user request; and generating signals for displaying a decision granting or denying the user request based on the second probability score.

In some embodiments, the major incident occurrence comprises an incident with one or more consequences meeting one or more predefined thresholds.

In some embodiments, the method may include using the probability score from the trained machine learning model as input to a decision tree model; and executing the decision tree model to determine the decision granting or denying the user request based on the probability score.

In accordance with yet another aspect, there is provided a non-transitory computer readable medium storing machine interpretable instructions, which when executed by a processor, cause the processor to perform: receiving a user request for accessing or modifying an electronic resource; processing the user request to obtain text data; applying feature engineering to the text data to output a feature matrix, the feature engineering comprising application of natural language processing to the text data; using a trained machine learning model to determine a probability score indicating a likelihood of incident occurrence as a result of the user request; and generating signals for displaying a decision granting or denying the user request based on the probability score.

### BRIEF DESCRIPTION OF THE FIGURES

In the Figures, embodiments are illustrated by way of example. It is to be expressly understood that the description and figures are only for the purpose of illustration and as an aid to understanding.

Embodiments will now be described, by way of example only, with reference to the below figures:

FIG. 1 shows an example system for managing electronic resource access, in accordance with some embodiments;

FIG. 2 is an example user interface for requesting access or modification of an electronic resource, in accordance with some embodiments;

FIG. 3 is a schematic block diagram of an example process for generating features based on a user request and using a trained machine learning model to generate an output based on the features, in accordance with some embodiments;

FIG. 4 is an example schematic flow chart for generating a probability score of an incident occurring using a trained machine learning model based on a user request, in accordance with some embodiments;

FIG. 5A shows another example schematic flow chart for generating a probability score of an incident occurrence using a trained machine learning model based on a user request, in accordance with some embodiments;

FIG. 5B each shows an example schematic flow chart for training a machine learning model for generating a probability score of an incident occurrence based on a user request, in accordance with some embodiments;

FIG. 5C each shows an example schematic flow chart for training a first machine learning models for generating a probability score of an incident occurrence based on a user request and a second machine learning models for generating a probability score of a major incident occurrence based on the same user request, in accordance with some embodiments;

FIGS. 6A and 6B each shows performance confusion metrics of a trained machine learning model, in accordance with some embodiments;

FIGS. 7A, 7B, 8A, 8B, 8C, 9A, 9B, 9C, 10A, 10B, 10C each shows various example feature data and graphs indicating an importance score of various feature data, in accordance with some embodiments;

FIG. 11 illustrates example global feature importance for a trained machine learning model, in accordance with some embodiments;

FIG. 12A illustrates example feature importance values in a graph, in accordance with some embodiments;

FIG. 12B illustrates example feature importance values by class in a graph, in accordance with some embodiments;

FIG. 13 shows an example schematic block diagram for a decision tree structure, in accordance with some embodiments;

FIG. 14 shows an example IT environment for providing relevant data for the decision tree structure in FIG. 13, in accordance with some embodiments;

FIG. 15 shows an example schematic block diagram for managing electronic resource access using both a trained machine learning model and a decision tree structure, in accordance with some embodiments;

FIGS. 16A and 16B each shows an example schematic block diagram for training a machine learning model in connection with a decision tree structure, in accordance with some embodiments;

FIG. 17 shows an example schematic diagram of a computing device that implements a system for managing electronic resource access, in accordance with some embodiments; and

FIG. 18 shows an example process performed by a system for managing electronic resource access, in accordance with some embodiments.

### DETAILED DESCRIPTION

As complexity of information technology (IT) platforms increase, and often with deployment of cloud platforms and distributed systems, components of various system components, which may include applications, servers, databases, are integrated across different operating environments to enable data flows and other functionalities. For example, an accounting system from one provider may be integrated with an inventory management system from a different provider. In order to connect the different applications, systems, databases with one another, application programming interfaces (APIs) are implemented for data and other types of integration.

An electronic resource in such environment may refer to any component deployed in an overall IT infrastructure, including for example, a software application, an interface protocol, a database, or an API.

When a user requests access or modification of an electronic resource (e.g., adding a data field to a payroll system to indicate a second bank account for a payee), if the access or modification is automatically granted without review, the granting of the user request may result in a breakdown in an existing integrated IT infrastructure, which may lead to costly errors or incidents. If each user request for access or modification is only granted after manual review, the collective manual review process would be a financial and resource burden to the organization.

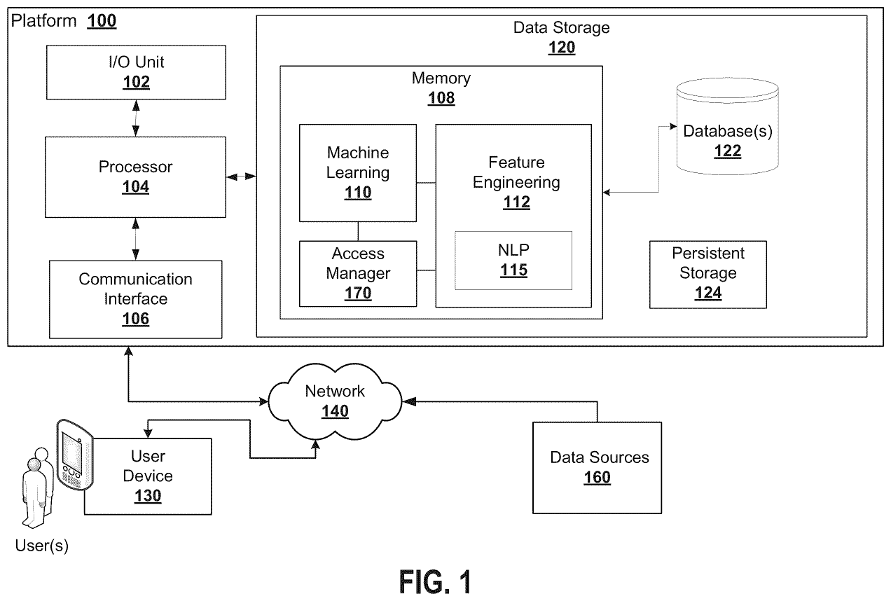

An example embodiment of a system, such as system 100 in FIG. 1, utilizes a trained machine learning model to analyze and process a given user request for accessing or modifying an electronic resource, and determine a probability of an incident occurrence caused by granting the user request. In some embodiments, a decision tree subsystem, referred to as “Change Autonomy”, is implemented in addition to the trained machine learning model, in order to speed up the change approval process by identifying low-risk change requests eligible for automatic approval. By proactively identifying incident-causing changes and automating low-risk approvals, efficiency, reliability, and overall operational effectiveness can be improved.

Throughout the disclosure and drawings, the trained machine learning model and the associated feature engineering/processing components may be collectively referred to as “Change Requests Causing Incidents”, or “CRCI” for short. It is to be understood however, a user accessing an electronic resource may also result in one or more modifications of the electronic resource without the user explicitly making any modifications to the resource; for instance, automatic modification of one or more properties or parameters of the electronic resource may occur based on the most recent user access (e.g., a previously private file accessible to a restricted group of users may be automatically set to public after a user outside of the restricted group has accessed it). Such modification caused by a user accessing an electronic resource may also lead to an incident.

In some embodiments, a trained machine learning model 110 is implemented to leverage diverse feature sets of user requests to classify requests with high probabilities of causing incidents. The trained machine learning model 110 generates an output indicating a probability of incident occurrence based on a feature matrix generated through feature engineering. The feature engineering may utilize Natural Language Processing (NLP) and other data processing to extract repeatable patterns recognized based on historical change and incident data.

In some embodiments, extracted feature sets used to generate the output indicating a probability of incident occurrence may include features from data in multiple text fields in the user request from a user, and other (e.g., categorical and numerical) features found within the user request.

In some embodiments, in order to train the machine learning model 110 to generate the probability of incident occurrence at inference time based on a given set of features obtained based on a user request, training data includes a set of features data in multiple text fields in historical user requests, and other (e.g., categorical and numerical) features found within the historical user requests, as well as a classification label (e.g., incident and/or major incident) for each feature set.

A decision tree subsystem, separate from the machine learning model 110, may include programmable instructions implementing an algorithm utilizing features and application level performance data recorded by an IT software, such as Integrated IT Portfolio Management (IIPM), to computationally assess if a user request is safe to be automatically approved. The decision tree subsystem reduces amount of manual review required by identifying safe user requests eligible for auto-approval.

In some embodiments, the trained machine learning model and the decision tree subsystem can run in parallel based on a user request, generating two outputs: 1. a probability of the user request causing an incident; and 2, whether the user request can be automatically approved. The first output may be used as a second validation for the second output to avoid automatic approval of user requests that may lead to unseen risky changes.

Based on historical data in a real world setting, approximately 1% of all user requests are responsible for 40% of major incidents within a large organization. When user requests require diligent reviewing by employees, such manual review can be time-consuming, prone to human errors, and result in delays.

In some embodiments, the trained machine learning system may be implemented to classify a seemingly-low-risk user request that may lead to an incident, or a major incident. Such seemingly-low-risk user request may have been approved in manual review by a human actor without use of the trained machine learning system. By accurately classifying user requests that may lead to incidents or major incidents within the IT infrastructure using embodiments described herein, IT incidents, including major incidents, can be reduced.

The described embodiments in this disclosure implement NLP techniques to analyze large-scale, sparse datasets, particularly text datasets, in order to generate a set of features, e.g., a feature matrix. The interoperation of advanced machine learning algorithms, NLP methods and comprehensive field analysis together can compute the patterns and insights that are otherwise difficult for humans to notice, particularly within the text fields. For example, vocabulary including one or more words used in the text fields, that may be indicative of a likelihood of causing an incident, are automatically extracted and processed to be part of features for a trained machine learning model.

In addition, system 100 may interoperate and communicate with various IT Service Management (ITSM) metrics, from incident reporting to problem identification tools, to assign a score to each user request, and/or auto-approve them with proper audit trails. Furthermore, a thorough list of features and their specific values are generated and rendered for any given user request to enhance the readability and explainability of the output from the machine learning model for governing purposes.

FIG. 1 is a high-level schematic diagram of an example computer-implemented system 100 (also referred to as platform 100) for managing access to electronic resources, exemplary of some embodiments.

System 100 includes an I/O unit 102, a processor 104, communication interface 106, and data storage 120. The I/O unit 102 can enable system 100 to interconnect with one or more input devices, such as a keyboard, mouse, camera, touch screen and a microphone, and/or with one or more output devices such as a display screen and a speaker.

Data storage 120 including a memory device 108 (also referred to as memory 108), a local database 122, and persistent storage 124. Memory 108 include one or more instruction modules stored thereon, such as for example, machine learning model 110, feature engineering module 112, and an access manager model 170. Feature engineering (FE) module 112 may include an NLP submodule 115 to process text data.

Processor 104 is configured to execute machine-executable instructions to perform processes disclosed herein, including computing a probability score based on instructions in machine learning model 110, determining a request denial or grant decision based on output from machine learning model 110 by an access manager 170, and generating feature matrix for the machine learning model 110 by the FE module 112.

System 100 can connect to an interface application installed on user device 130 to exchange signals representing a route plan. The interface application interacts with the system 100 to exchange data (including control commands) and generates visual elements for display at user device. The visual elements can represent one or more decisions for granting or denying a user request, for example.

System 100 can connect to different data sources, including third party sources to receive input data or to transmit other data. For instance, system 100 can receive and transmit asset data from internal and/or external data sources 160. The data can be transmitted and received via network 140 (or multiple networks), which is capable of carrying data and can involve wired connections, wireless connections, or a combination thereof. Network 140 may involve different network communication technologies, standards and protocols, for example.

Processor 104 can execute instructions in memory 108 to implement aspects of processes described herein. Processor 104 can execute instructions in memory 108 to configure various components and functions described herein. Processor 104 can be, for example, any type of general-purpose microprocessor or microcontroller, a digital signal processing (DSP) processor, an integrated circuit, a field programmable gate array (FPGA), a reconfigurable processor, or any combination thereof.

Memory 108 may include a suitable combination of any type of computer memory that is located either internally or externally such as, for example, random-access memory (RAM), read-only memory (ROM), compact disc read-only memory (CDROM), electro-optical memory, magneto-optical memory, erasable programmable read-only memory (EPROM), and electrically-erasable programmable read-only memory (EEPROM), Ferroelectric RAM (FRAM) or the like. Data storage devices 120 can include memory 108, databases 122, and persistent storage 124.

Communication interface 106 can enable system 100 to communicate with other components, to exchange data with other components, to access and connect to network resources, to serve applications, and perform other computing applications by connecting to a network (or multiple networks) capable of carrying data including the Internet, Ethernet, plain old telephone service (POTS) line, public switch telephone network (PSTN), integrated services digital network (ISDN), digital subscriber line (DSL), coaxial cable, fiber optics, satellite, mobile, wireless (e.g. Wi-Fi, WiMAX), SS7 signaling network, fixed line, local area network, wide area network, and others, including any combination of these.

System 100 can be operable to register and authenticate users (using a login, unique identifier, and password for example) prior to providing access to system 100. For example, user authentication process may be handled via an authentication module (not shown).

Data storage 120 may be configured to store information associated with or created by the components in memory 108 and may also include machine executable instructions. Memory 108 may be persistent memory storage. Data storage 120 includes a persistent storage 124 which may involve various types of storage technologies, such as solid state drives, hard disk drives, flash memory, and may be stored in various formats, such as relational databases, non-relational databases, flat files, spreadsheets, extended markup files, etc.

Access manager model 170 in system 100 is configured to receive one or more user requests and determine, based on output from a machine learning (ML) model 110, if each user request is likely incident-causing or otherwise. When a user request is determined to likely cause an incident or major incident, the access manager 170 may deny the user request and transmit a message to the user regarding the denial.

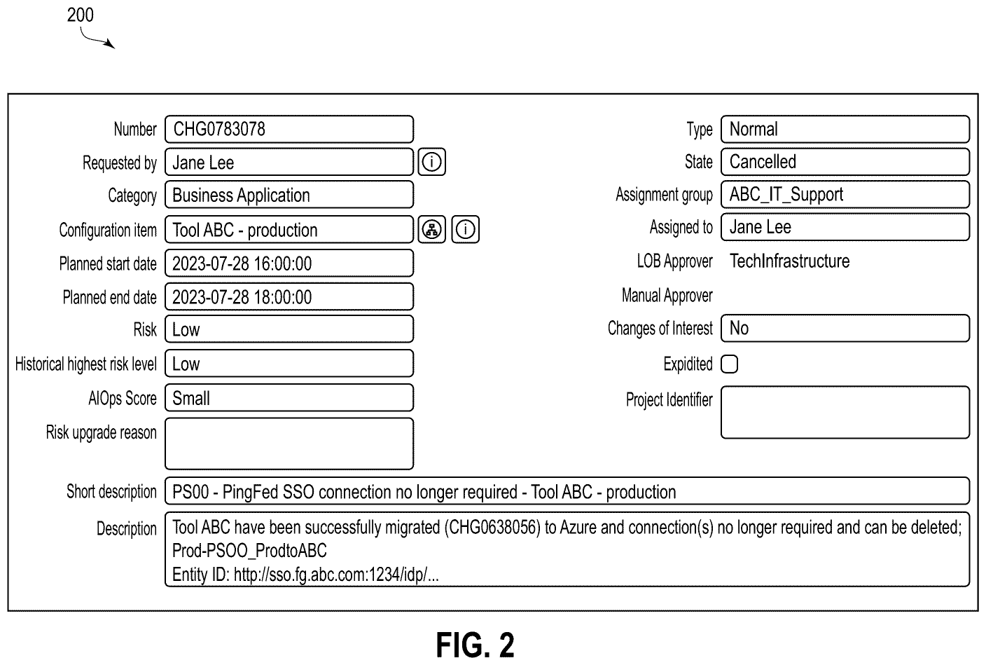

The ML model 110 is configured to, during a training stage, dynamically learn from historical user requests (such as change requests) and incident data in order to accurately predict the likelihood of an incident occurring. FIG. 2 shows an example user interface 200 for a user request for modifying an electronic resource. The user request in this case is a change request with a request number CHG0783078, as requested by user Jane Lee. The electronic resource that is the subject of the change request is Tool ABC—production, which is a user input in the field “configuration item”. The user request includes one or more additional fields regarding the electronic resource, including for instance, a category, planned start date, planned end date, a risk level, a historical highest risk level, an artificial intelligence for IT operations (AIOps) score, a reason for upgrading (“risk upgrade reason”), a short description of the request, a full description of the request, a type of the request, a state of the request, an assignment group, an assignee, a line of business (LOB) approver, a manual approver, a change of interest, an expedited option, and a project identifier.

System 100 may be a system in an IT ecosystem deployed to manage IT assets and software for a corporation. System 100 may interface with one or more data sources 160, including for example an IT management platform, and/or a system (e.g., ServiceNow™) for reporting and storing incident data.

Input data may be received by system 100 from the above mentioned data sources for training machine learning model 110 in a training phase, or to assist assess manager 170 to process a user request using a decision tree subsystem.

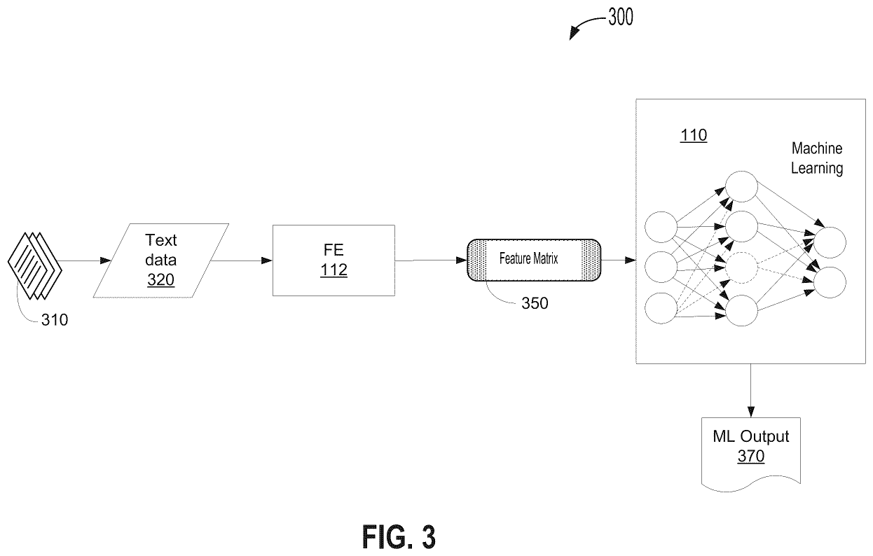

FIG. 3 is a simplified schematic block diagram of an example process 300 for generating a feature matrix 350 based on a user request 310 and using a trained machine learning model 110 to generate an output 370 based on the feature matrix 350, in accordance with some embodiments. In some embodiments, machine learning model 110 can include an input layer, a hidden layer, and an output layer. machine learning model 110 is stored and maintained on system 100 and is part of an overall technical infrastructure adapted to provide a technical benefit of overall increased accuracy and efficiency at inference time.

A user request 310 includes data gathered from the user, such as through the user interface 200 in FIG. 2, and includes text data 320. The text data 320 are processed via a feature engineering model 112 to generate a feature matrix 350. The feature matrix 350 is processed by a trained machine learning model 110 to generate an output at inference time, the output may include a probability of the user request 310 causing an incident or a major incident.

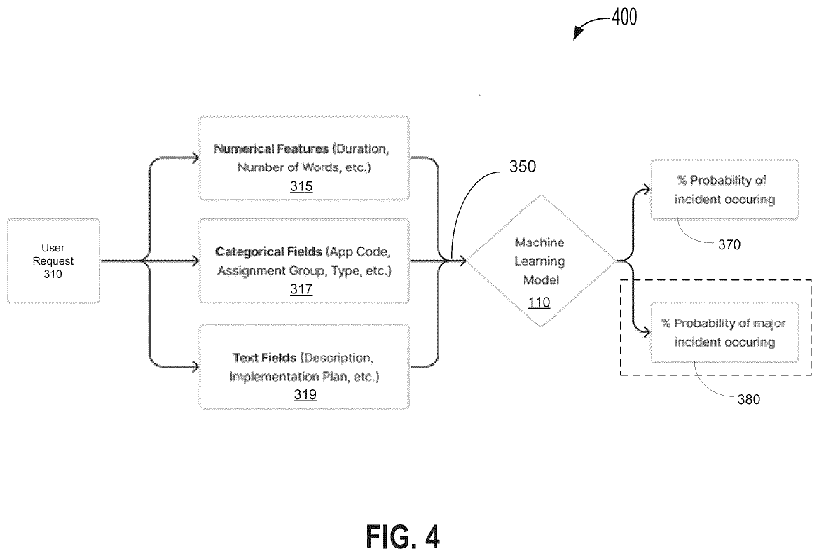

FIG. 4 is an example schematic flow chart 400 for generating a probability score 370 of an incident occurring using a trained machine learning model 110 based on a user request 310. The machine learning model 110 may be trained, in some embodiments, to output one or both of: a first probability score 370 indicating the user request causing an incident and a second probability score 380 indicating the user request causing a major incident. That is, the machine learning model 110 may be configured, prior to inference time, to generate either or both probability output 370, 380.

A major incident is a subcategory of incident, and an incident is classified as a major incident when the potential consequences of the incident meet one or more predefined thresholds. For example, a major incident may be an incident that may lead to an operation problem that may last over 24 or 48 hours. For another example, a major incident may be an incident that may lead to a financial loss in the amount of 10,000 dollars or more. Each incident report used to generate training data for training the machine learning model 110 has a corresponding label indicating if the incident is a major incident.

During training of the machine learning model 110, historical user requests and incident records in the past twelve months from a data source 160 (e.g., ServiceNow™ system) are obtained to generate a training dataset. From the incident records, all incidents recorded to have been caused by one or more user requests including change requests are collected. This collected information can then be mapped to the user request data in one or more historical user requests, and the historical user requests can be labeled as either having caused at least one incident or not (caused_incident=True or caused_incident=False). An additional label to indicate whether the change caused a major incident can be added based on the severity of that incident (caused_major_incident=True/False), making this a multi-label classification problem.

### Feature Engineering

Feature engineering described below may be referenced in the context of generating features based on historical data to train the machine learning model. It is to be understood that similar feature engineering techniques, including NLP techniques, can be used to generate features (e.g., feature matrix 315) for the trained machine learning model 110 to receive as input in order to generate a probability score indicating an incident-causing likelihood for a given user request 310 at inference time.

From the training dataset, two main sets of features are extracted from the user request data. The first set includes categorical and numerical data found in user requests. The second set involves data obtained from text fields within the user request entered by the user submitting the user request.

Table 1 below provides example features 315, 317, 319 obtained from the training dataset. Categorical features 317 and numerical features 315 from the user request data were selected based on the distribution of values and their informativeness to the machine learning model 110. For example, fields that are often empty or have the same value distribution for the majority of changes are excluded as they provide limited information in the analysis. Text field features 315 are text data filled by the user in text fields present in a user request.

TABLE 1

| Feature Subset | Included features |
|---|---|
| Categorical | Category |
| Features 317 and | Subcategory |
| Numerical | Type |
| Features 315 | Duration (Planned Start-Planned End) |
| | Configuration Item |
| | Configuration Item Class (CI Class) |
| | App Code |
| | Assignment Group |
| | LOB Approver |
| | Business Application |
| | Conflict Status |
| | Organization Levels L2, L3, L4, and L5 |
| | Risk |
| Text Features 319 | Description |
| | Short Description |
| | Implementation Plan |
| | Backout Plan |
| | Test Plan |

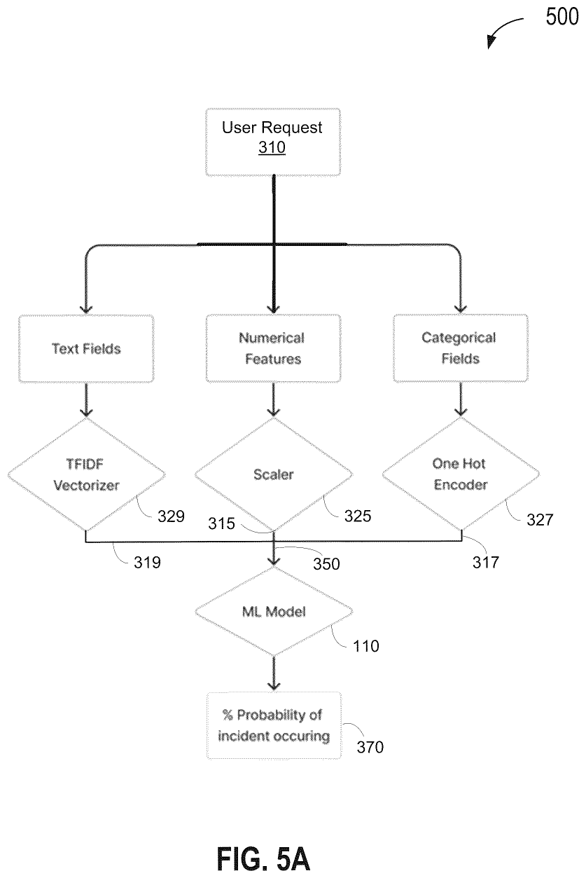

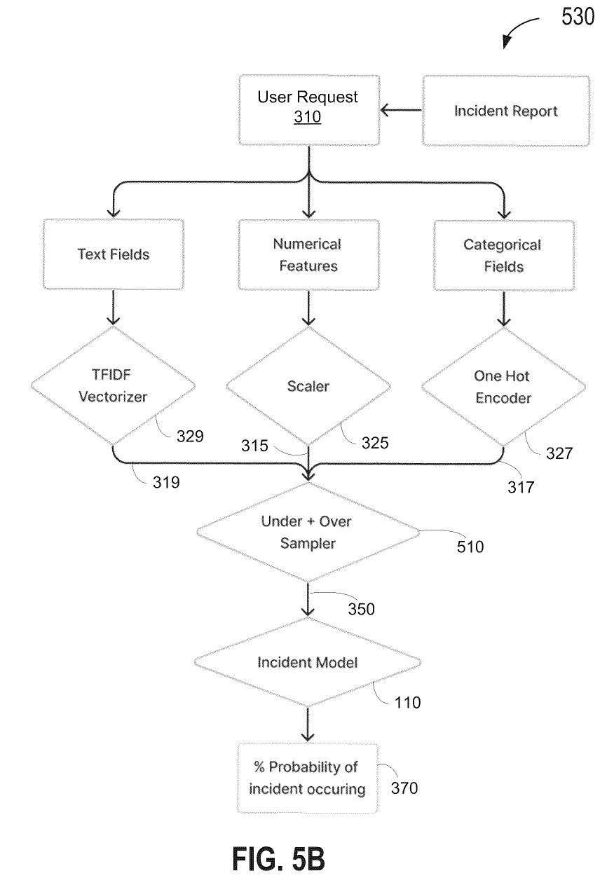

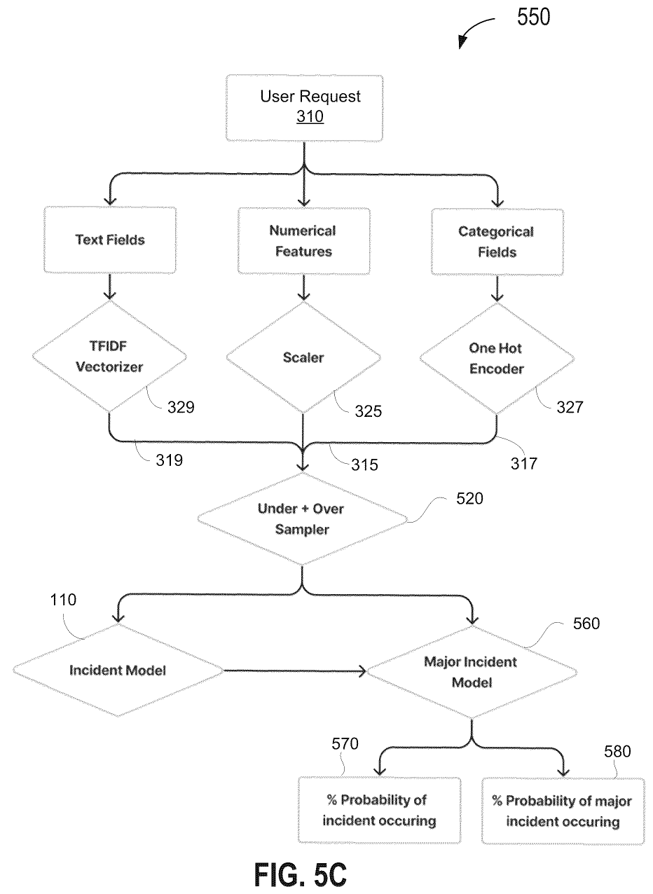

FIG. 5A shows another example schematic flow chart 500 for generating a probability score 370 of an incident occurrence using a trained machine learning model 110 based on a user request 310. While FIG. 5B shows an example schematic flow chart 530 for training the machine learning model 110 based on user requests 310 and incident reports.

For text features 319, analyzing data in text fields presents a more complex challenge, as they do not have predefined values and can thus vary significantly based on the user filling out the user request. To identify patterns within these fields for generating one or more text features 319, two types of features are extracted from the text data in the user request, a first type is meta features from each text field, which include:
Number of words
Number of stopwords (e.g. and, the, it, of, etc)
Number of punctuations
Number of upper-case words.

Next, word content and vocabulary used in each text field is analyzed using NLP techniques 115. To convert the text into a format suitable for the machine learning model 110, a TFIDF (Term Frequency—Inverse Document Frequency) vectorizer 329 is implemented to generate a matrix of word frequency counts readable by the machine learning model 110. TFIDF is the product of two statistics, term frequency and inverse document frequency, and uses the frequency of words to determine how relevant those words are to a given document.

To ensure that the categorical features 317 can be properly interpreted by machine learning model 110, one-hot encoding technique 327 is applied to the categorical fields and the number of possible categories were limited to reduce computational complexity. An example is shown below in Table 2.

TABLE 2

Input:
Business
Application
Infrastructure

Output:

| category_business_application | category_infrastructure |
|---|---|
| 1 | 0 |
| 0 | 1 |

To normalize numerical features (e.g., meta features and duration), data in the numerical fields are scaled with a scaler 325 to be within a given range of 0 to 1. After all features 315, 317, 319 are generated, they are combined to create a high-dimensional sparse matrix of features 350 for machine learning model 110. See an example of the input and output of numerical and text features below in Table 3.

TABLE 3
Input:

| num_words_desc | description | . . . |
|---|---|---|
| 10 | This is an example of a text field | |
| 20 | Another example | |

Output:

| num_words_desc | description_example | description_another | description_text | . . . |
|---|---|---|---|---|
| 0.5 | 0.5 | 0 | 0.4 | |
| 0.7 | 0.5 | 0.2 | 0 | |

Once the feature matrix 350 is generated, it can be used as input to train (during a training phase) the machine learning model, or used as input to generate a probability score 370 indicating an incident occurrence as a result of user request 310.

In some embodiments, in order to address a varying levels of severity of incidents caused by changes, a multi-label classification machine learning model is implemented as machine learning model 110, to generate two probability scores 370, 380 (e.g., values represented by caused_incident and caused_major_incident), one for indicating incident occurrence of normal or non-major nature, and one for indicating a probability of occurrence of major incidents. For example, in some embodiments, a two-classifier machine learning model is implemented to not only classify changes as incident causing, but predict whether they are likely to cause a major incident as well.

When training a machine learning model for multi-classification, two distinct labels are used in the training dataset, each for a respective classifier. The first classifier is trained to predict whether a given user request will likely lead to an incident. In parallel, the second classifier is trained to predict if the same user request will likely lead to a major incident. As shown in FIG. 5C, when there exists some inherent correlation between two classes, a technique known as Classifier Chaining may be implemented, where an output from a first machine learning model 110 acting as the first classifier is added as input to the second machine learning model 560 acting as the second classifier. In this example embodiment, the output includes two probability scores 570, 580: one for indicating incident occurrence of normal or non-major nature, and one for indicating a probability of occurrence of major incidents.

In some embodiments, as shown in FIG. 5B and FIG. 5C, during training of machine learning model 110 and/or machine learning model 560, a sampling process 510, 520 may be implemented to solve a technical problem caused by data imbalance in training data. The challenge of a largely imbalanced dataset is presented when, among historical data, user requests that have not caused incidents outnumber user requests that have caused incidents by a ratio of 145:1. User requests causing a major incident occupy an even smaller portion of the training dataset, with ratio of 2214:1 between the user requests causing a major incident and the user requests that have not caused any incident. Due to this gap, it is likely that a machine learning model will be highly biased towards the majority class (caused_incident=False).

In addition, the training dataset includes a diverse set of features (i.e. TFIDF, numerical, categorical).

To optimize performance of the machine learning models 110, 560, a combination of random under sampling of the majority class and random over sampling of the minority class may be implemented to deal with this imbalance in this sparse dataset, during the training phase of each machine learning mode 110, 560, as indicated in FIGS. 5B and 5C.

To address this problem, in some embodiments, such as the one shown in FIGS. 5B and 5C, a combination of under sampling and over sampling methods at step 520 is implemented to even out the classes prior to training. First, the training features are under-sample by randomly selecting data points from the majority class, until the ratio of minority:majority is 0.80:1. Then, the minority class is randomly sampled until the classes are even. As the machine learning models are trained for a multi-label classification problem, the sampling at step 520 is done for training data with both labels—incident causing and major incident causing.

Once the training dataset has undergone through sampling at step 510, 520, with all the processed TFIDF, meta, and categorical features, the training data including all the features 315, 317, 319 are used to train the two machine learning models 110, 560. In some embodiments, each of machine learning models 110, 560 is a Logistic Regression model, with model 110 to identify incidents, and model 560 to identify major incidents, through classifier chaining. Other classifiers, such as Random Forest and XGBoost may also be used to implement one or both of machine learning models 110, 560. Logistic Regression was chosen in experiments due to its simplicity, speed, performance and interpretability.

These trained models can then be used for prediction of new, unseen user requests 310 received from user interface 200, to generate two output values: two probability scores 570, 580, one for indicating incident occurrence of normal or non-major nature, and one for indicating a probability of occurrence of major incidents.

### Performance Data

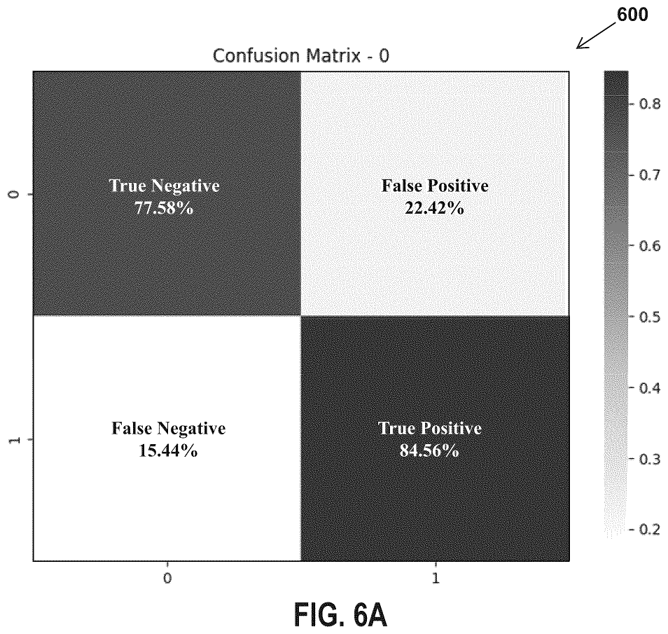

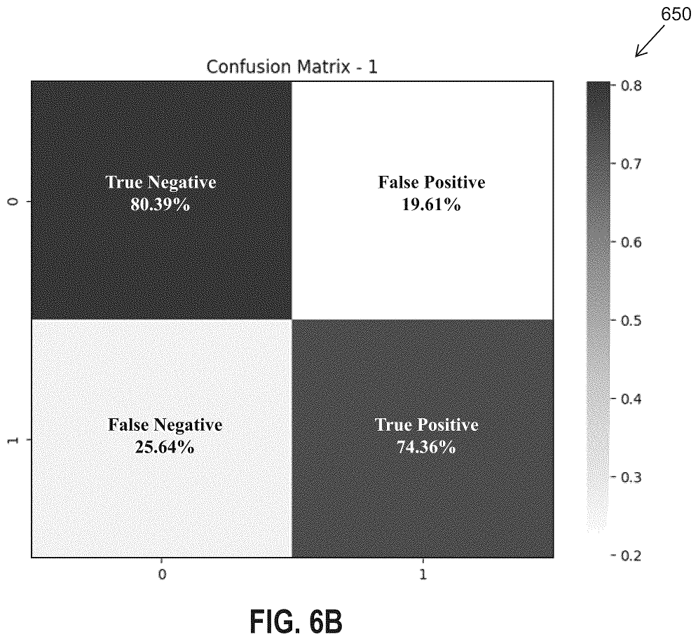

To measure performance of the machine learning model 110, a 3-fold cross validation was performed on the training dataset, using balanced accuracy and recall score as metrics. The confusion matrices can be found in FIGS. 6A and 6B. FIG. 6A shows a confusion matrix 600 for incidents, and FIG. 6B shows a confusion matrix 650 for major incidents, showing the distribution of the model predictions. A Table 4 containing performance metrics for the two-classifier approach is shown below.

TABLE 4

| | | | | | Recall |
|---|---|---|---|---|---|
| Incident | | Recall | Major | Recall | (Non- |
| Model | Recall | (Non- | Model | (Major | Major |
| Balanced | (Incident | Incident | Balanced | Incident | Incident |
| Accuracy | Causing) | Causing) | Accuracy | Causing) | Causing) |
| 81.1% | 77.6% | 84.6% | 77.4% | 74.4% | 80.4% |

Traditional machine learning models such as neural network, although performant, are complex and lack transparency when it comes to interpretability. For this reason, they can be referred to as black box models, where the data is coming in, predictions are coming out, and the logic inside that leads to these predictions is unknown.

Although prediction accuracy is important when implementing and training a machine learning model, interpretability of these results is critical as well.

System 100 can provide not only the probability of an incident occurring, but also give a reasoning behind that prediction. As shown below, a tool is implemented to use the trained models 110, 560 to make localized predictions, while outputting the feature values use to make this decision.

To show explainability of machine learning model 110, 560 in view of the predictions made, LIME, a local explanation library is used to make interpretation of the model.

Two explainer models from LIME, LIMETextExplainer, which explains the output of text classifiers, and LIMETabularExplainer, which deals with categorical and continuous data, are implemented. Two separate machine learning models are trained to input into each of the mentioned explainer models—one with just the text fields as features, and another with the remaining categorical and numerical features.

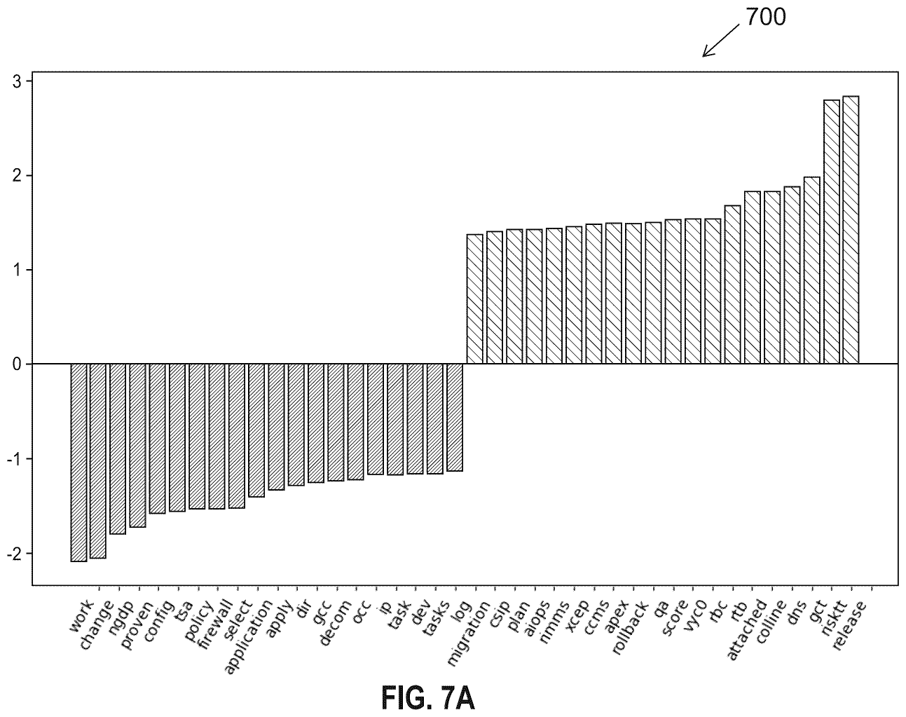

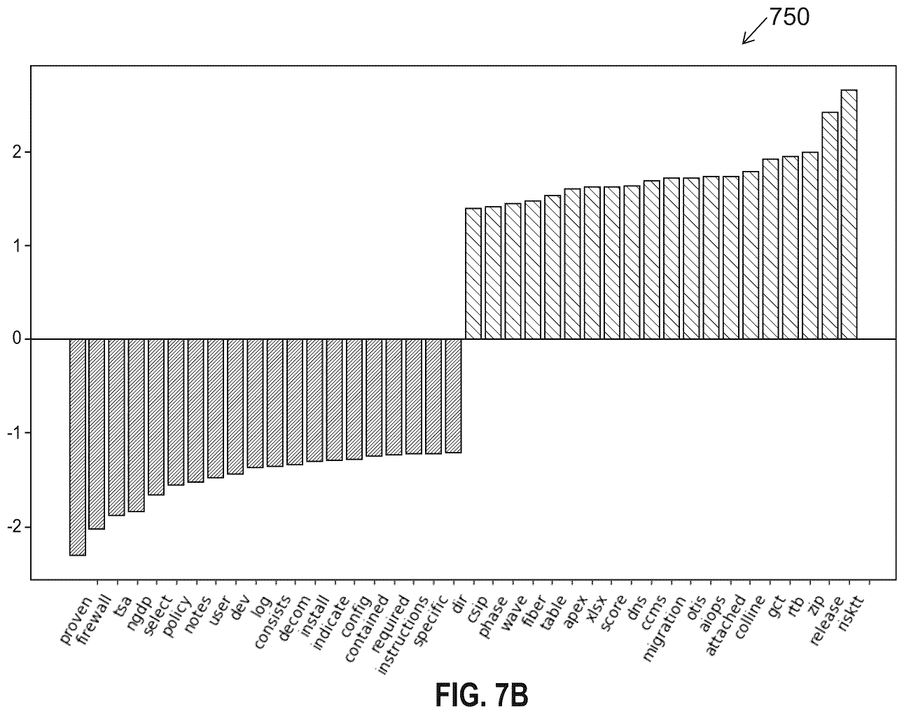

As part of the process for creating an interpretable model trained on text features 319, several iterations of models were created and validated using cross-validation. In addition, a feature importance study was conducted to retrieve the words in the change vocabulary that were most informative to the model for each class. In FIG. 7A, twenty most informative words for the model from each category are shown in the graph 700, where 20 words that are deemed as most relevant to caused incidents are shown in on the right hand side, and 20 words that are deemed as least relevant to caused incidents are shown on the left hand side, each with a respective feature importance value along y-axis.

As a result, several key words were identified that were held on tightly by the model, but were neutral terms that do not help with interpretability. These include words such as: change, assignee, implementation, ensure, plan, test, description, task, RBC, notes and number.

These are words that were ranked highly by the model as it was trained, but aren't specifically informative to users. Thus, these words were removed from the vocabulary, with no loss to model performance as a consequence. An updated list of words are shown in graph 750 in FIG. 7B, where 20 words that are deemed as most relevant to caused incidents are shown in on the right hand side, and 20 words that are deemed as least relevant to caused incidents are shown on the left hand side, each with a respective feature importance value along y-axis.

The machine learning model 110, 560 can be trained using words that are more meaningful for users. LimeTextExplainer( ) is used to generate localized explanations on predictions. As an output, the explainer provides the predicted probability of causing an incident, the top words that contributed to the decision from each class, and a display of those words highlighted in the original text field. In the examples below, user requests that caused major incidents are listed and described.

Example 1, features from user request includes:
Number: CHG0750337
Caused Major Incident: True
Type: Standard
Category: Business Application
Subcategory: None
Assignment Group: ABC_LINUX
Configuration Item (CI): Linux Support Group—Prod
CI Class: cmdb_ci
App Code: UTI0
Business Application: Linux Support Group
Lob Approver: None
L2/L3/L4/L5: Bruce Jones, Nick Smith, Lauren Adams, Tom Hudson
Conflict status: No Conflict
Risk: 4 (Low)
Duration: 256 hrs

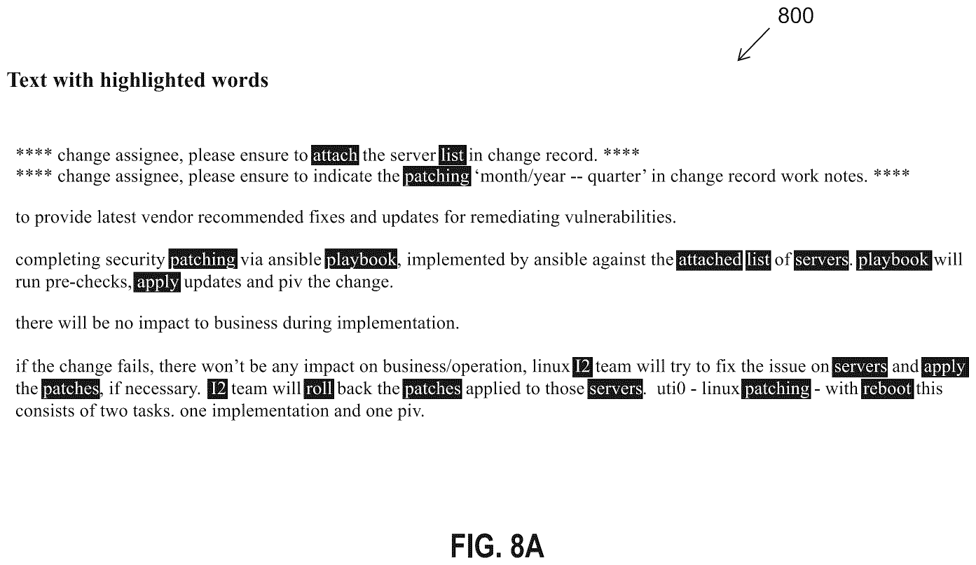

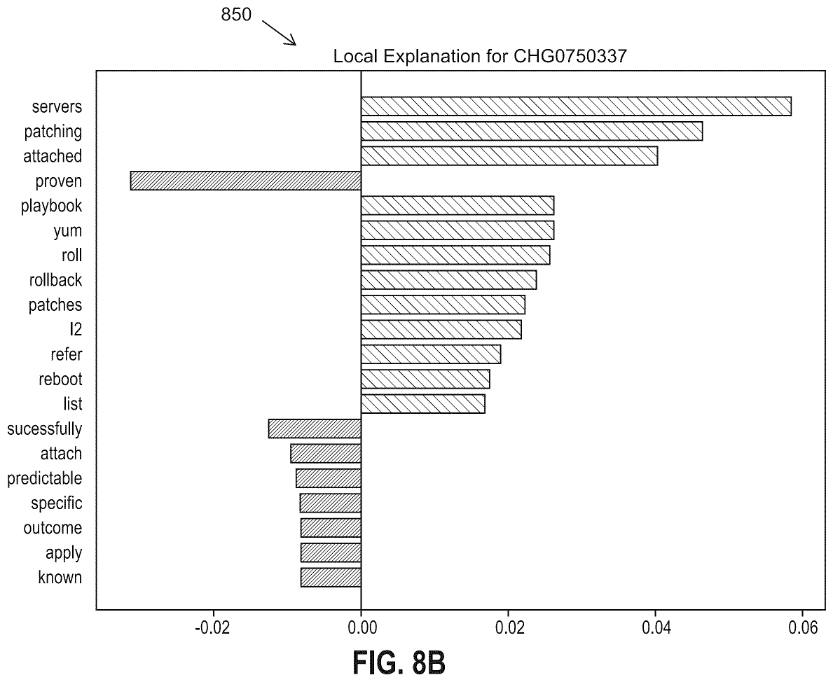

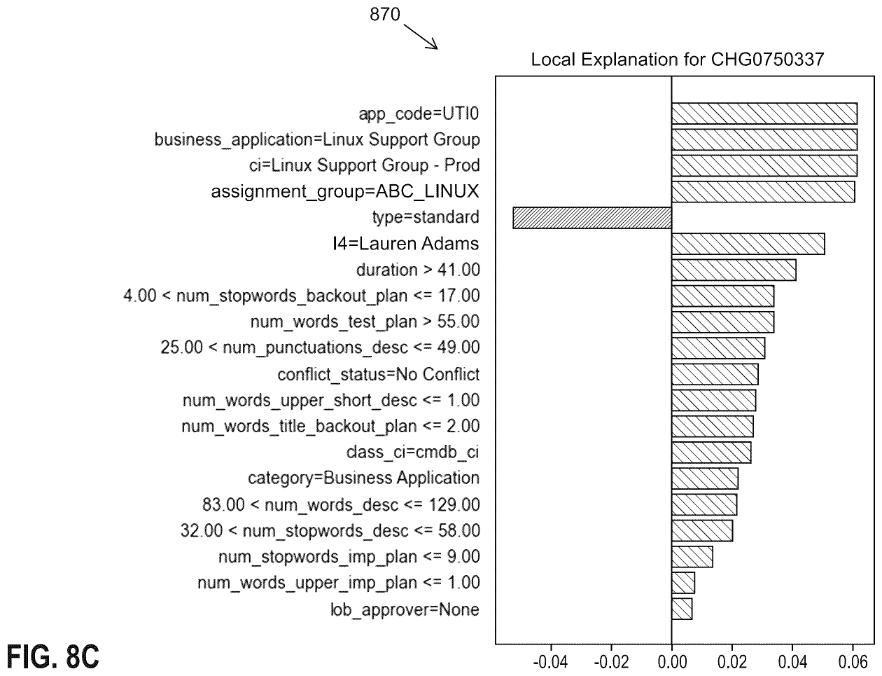

For Example 1 above, the Predicted Probability of Incident is 73%. FIG. 8A shows example text fields with highlighted words that contributed to the Predicted Probability of Incident in an example user request 800. FIG. 8B shows a corresponding graph 850 for the example text fields in FIG. 8A.

Example 2, features from user request includes:
Number: CHG0668788
Caused Major Incident: True
Type: Normal
Category: Business Application
Subcategory: None
Assignment Group: XYZ_RISK
Configuration Item (CI): Lombard Risk Colline_Acadiasoft MarginSphere—Prod
CI Class: cmdb_ci
App Code: SXV0
Business Application: None
Lob Approver: QA Team
L2/L3/L4/L5 Organization Level: Derek Dobson, Jeremy Mansfield, Harry
Smith, Paul Lombard
Conflict status: No Conflict
Risk: 4 (Low)
Duration: 63 hrs

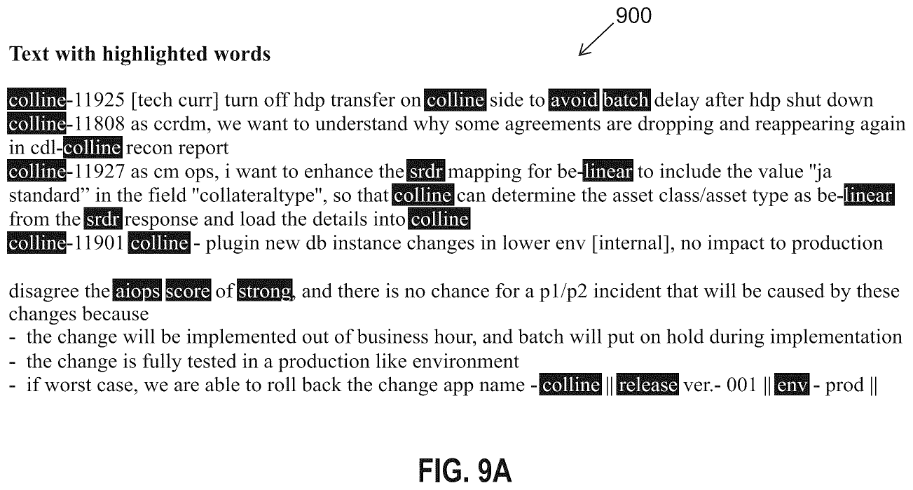

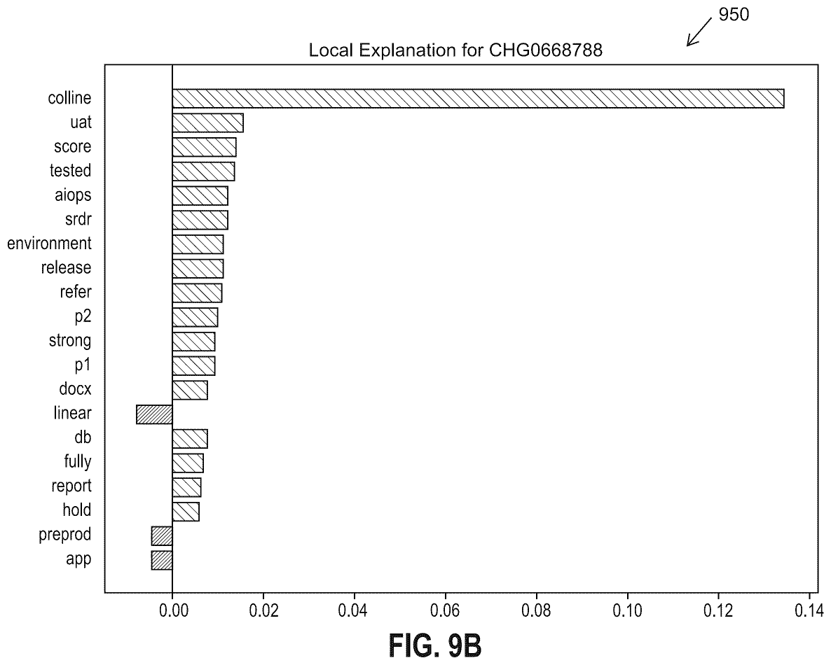

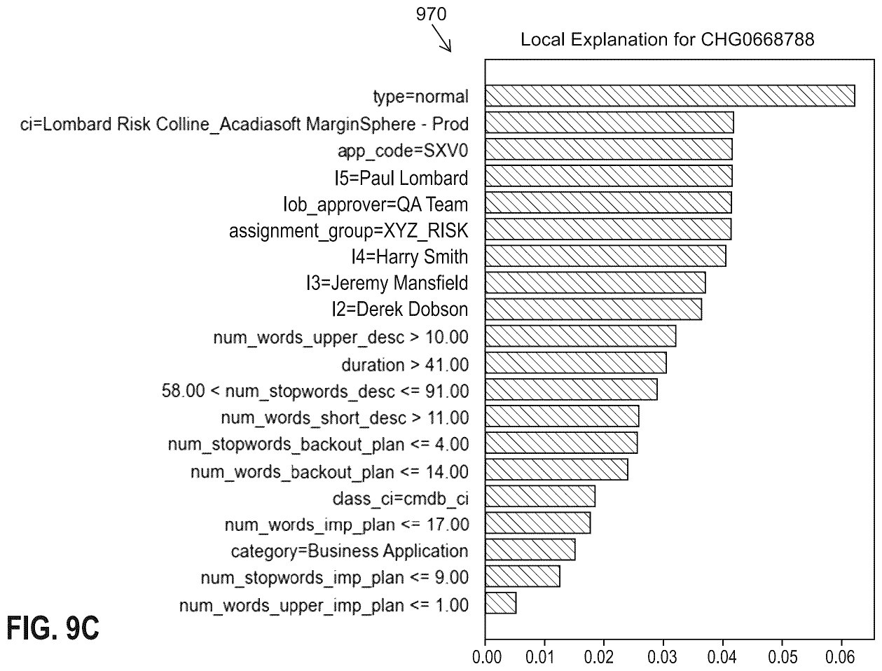

For Example 2 above, the Predicted Probability of Incident is 92%. FIG. 9A shows example text fields with highlighted words that contributed to the Predicted Probability of Incident in an example user request 900. FIG. 9B shows a corresponding graph 950 for the example text fields in FIG. 9A.

Example 3, features from user request includes:
Number: CHG0592843
Caused Major Incident: True
Type: Normal
Category: Infrastructure
Subcategory: Logical Change
Assignment Group: HJK_FIREWALLS
Configuration Item (CI): SCCPADGF01P
CI Class: uvw_firewall
App Code: None
Business Application: None
Lob Approver: Technology Team
L2/L3/L4/L5 Organization Level: Bruce Jones, Emily Smith, Matthew Howard, Max Chin
Conflict status: Not Run
Risk: 4 (Low)
Duration: 57 hrs

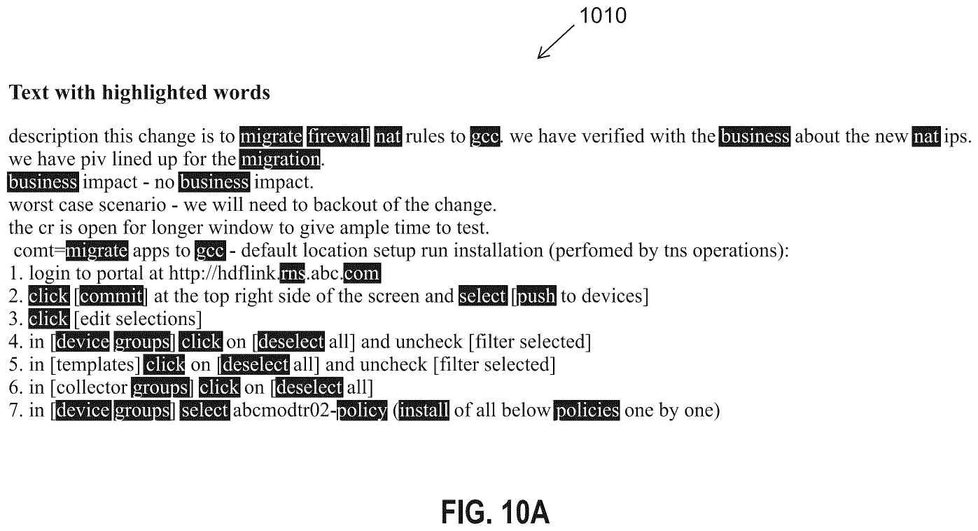

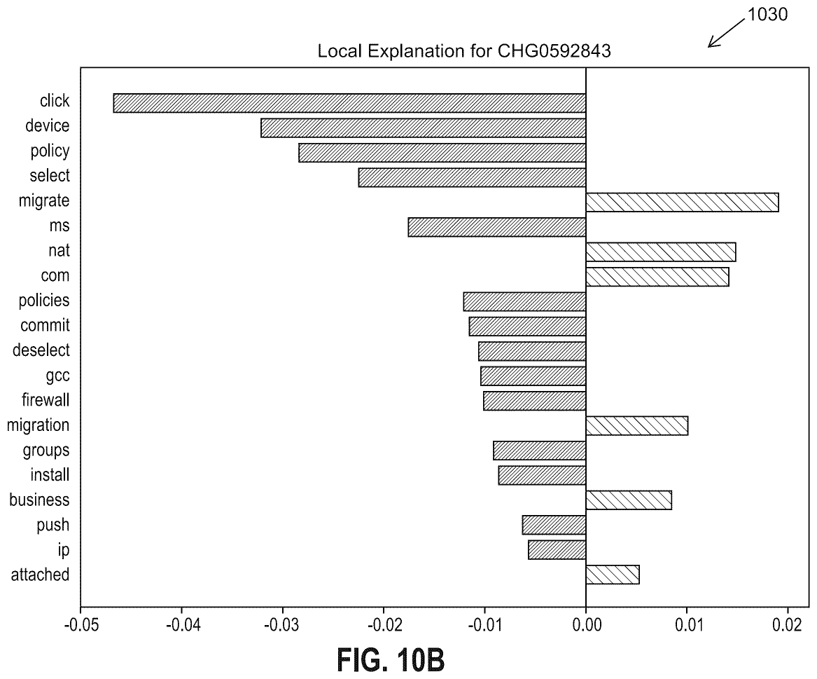

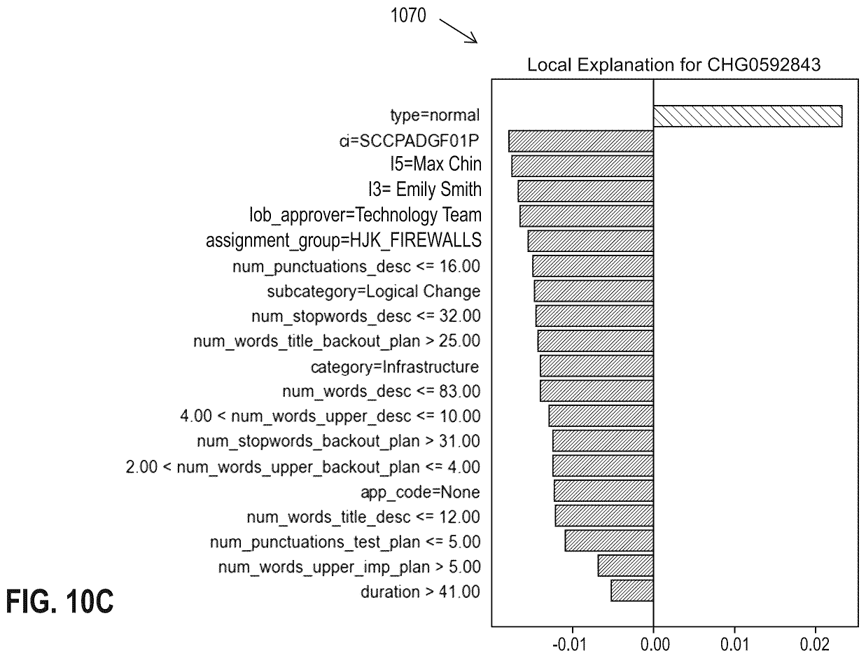

For Example 3 above, the Predicted Probability of Incident is 21%. FIG. 10A shows example text fields with highlighted words that contributed to the Predicted Probability of Incident in an example user request 1010. FIG. 10B shows a corresponding graph 1030 for the example text fields in FIG. 10A.

For categorical and numerical features, process is similar to what was done with the text features, but using the LimeTabularExplainer to describe the outcome of the classifier trained with the categorical and numerical features. For Example 1, a Predicted Probability of Incident is 85%, with FIG. 8C showing an explanation of prediction in graph 870. For Example 2, a Predicted Probability of Incident is 98%, with FIG. 9C showing an explanation of prediction in graph 970. For Example 3, a Predicted Probability of Incident is 13%, with FIG. 10C showing an explanation of prediction in graph 1070.

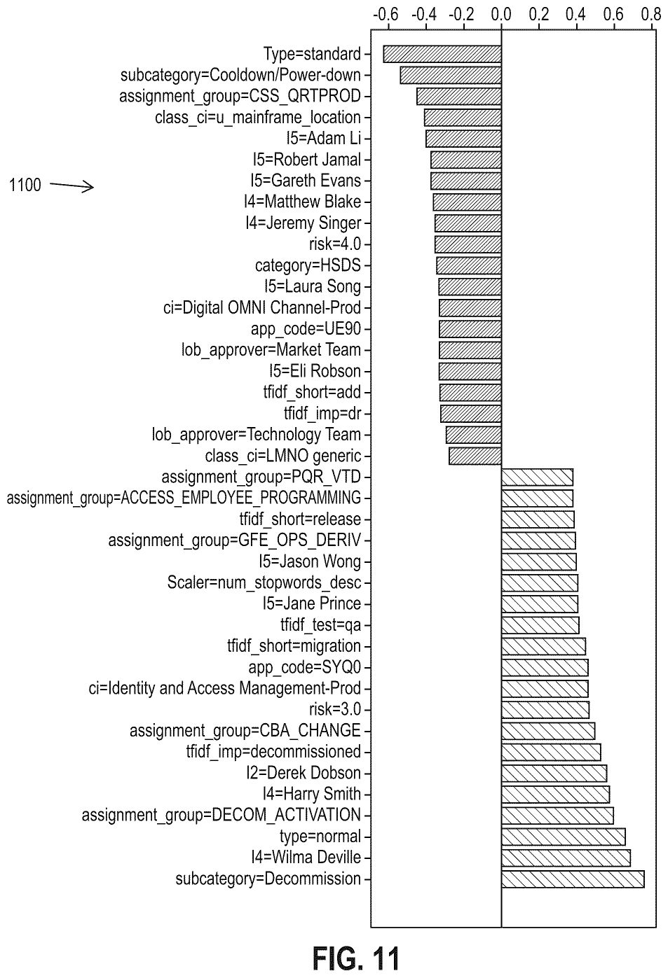

Although local feature importance is important to understanding the mechanisms behind individual predictions, it is also important to consider how the model makes its decisions on a whole. One way to find these important variables is to look at the coefficient/feature importance values from the model itself. FIG. 11 shows a graph 1100 illustrating global feature importance of all features for a trained LogisiticRegression model implemented as example machine learning model 110.

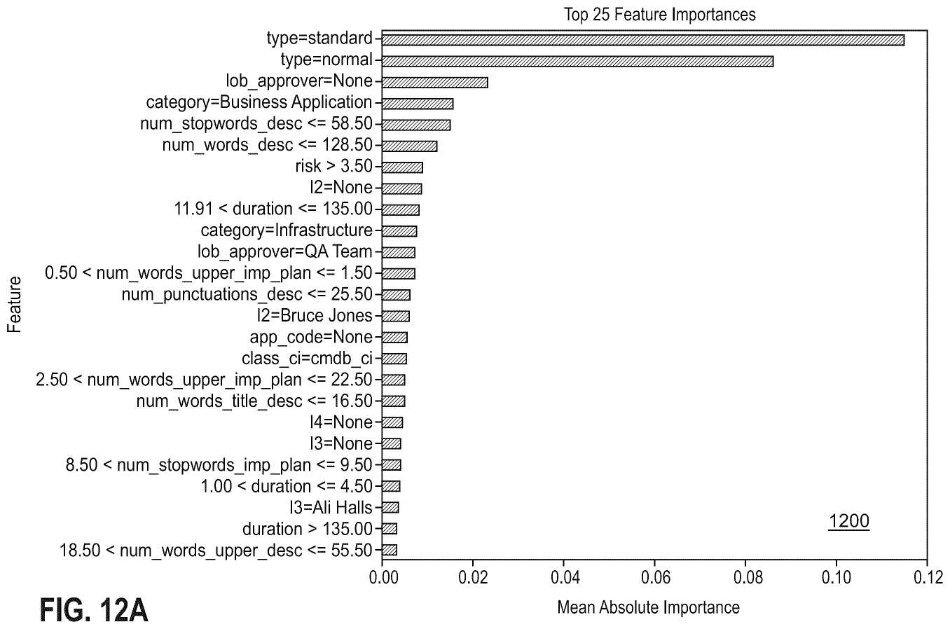

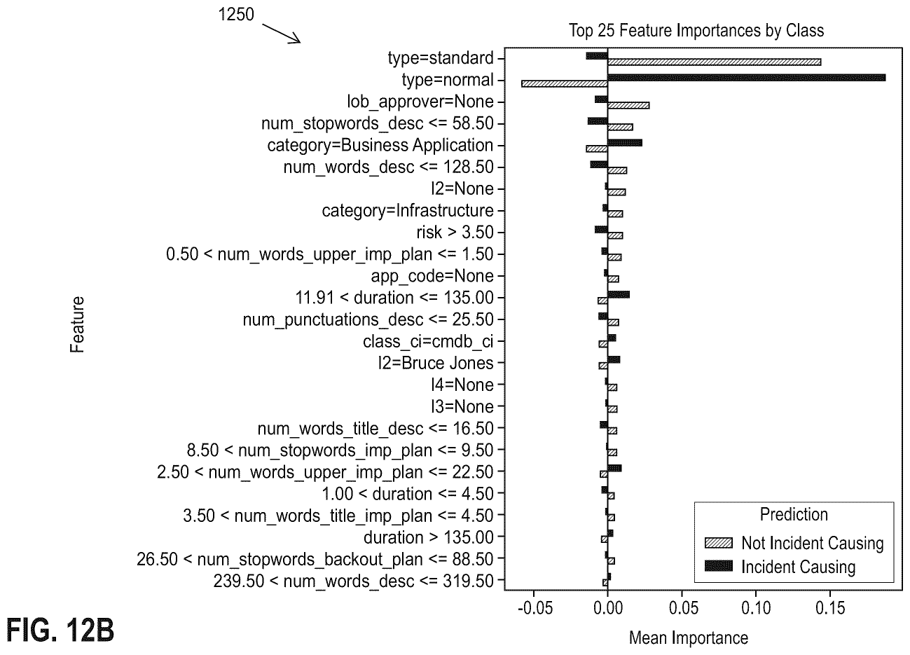

Another method to show global importance of features is using the SubmodularPick available in LIME to calculate the global importance. FIGS. 12A and 12B illustrate some examples of tabular (categorical+continuous) variables ranked by their overall contribution to the model. FIG. 12A shows top 25 feature importance in graph 1200, and FIG. 12B shows top 25 feature importance by class in graph 1200, where the top 25 variables globally important to the model are shown then this distribution broken down by class. These values are retrieved through the calculation and averaging of local importance values from a series of representative samples to the dataset.

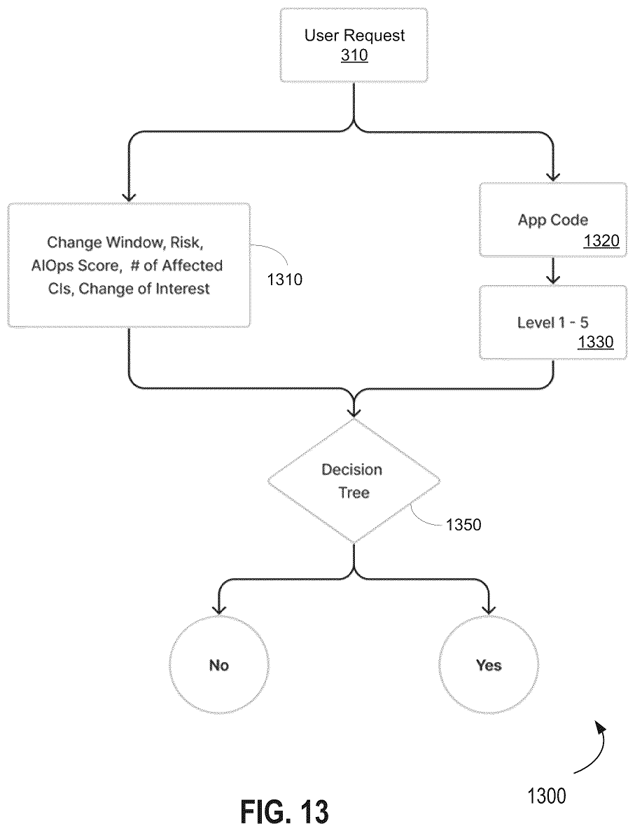

In some embodiments, a decision tree subsystem 1300 including a decision tree based algorithm 1350 implementation may be part of system 100. As shown in FIG. 13, the decision tree subsystem 1300 may receive various user request fields and IIPM data to output whether a change can be automatically approved. When provided with a user request 310, it considers two main factors as input.

First, information about the application code (“app code”) 1320 of the team making the user request is extracted and a level value 1330 from 1-5 is assigned to that app code 1320. This level is based on an assessment of the number of major incidents caused by that app code in the past two years, whether the app code is in change remediation, crown jewel status, business criticality and SOX/SOC1 compliancy.

The decision tree subsystem is implemented to obtain user request data 1310 from the use request 310, including for example: the access or change window (planned start—planned end), risk of the access or change in the user request, the generated AIOps score, the number of configuration items affected by the user request, and whether the access or change is a change of interest.

The app code level (e.g., from 1 to 5) 1330 and user request data 1310 is then used as input for the decision tree 1350, which performs a series of steps to determine if this change is safe to automate. In some embodiments, one or more steps may include determining if one or more requirements from the list below are met:
1. AIOps Score is low
2. Change is low risk
3. Change is not a “Change of Interest”
4. Total change window is less than 12 hours
5. App/Infrastructure is not: Crown Jewel, Business Critical, SOX/SOC1 compliant
6. Zero major incidents caused by requesting group in the last 12 months
7. Number of related app codes and CIs is less than 10 (IIPM)
8. Completed risk self-assessment
9. Requesting group and CI is not in “Change remediation”
10. No open program tasks associated with a major incident caused by requesting group
11. The first time a change of this type is performed, it must have review/approval.

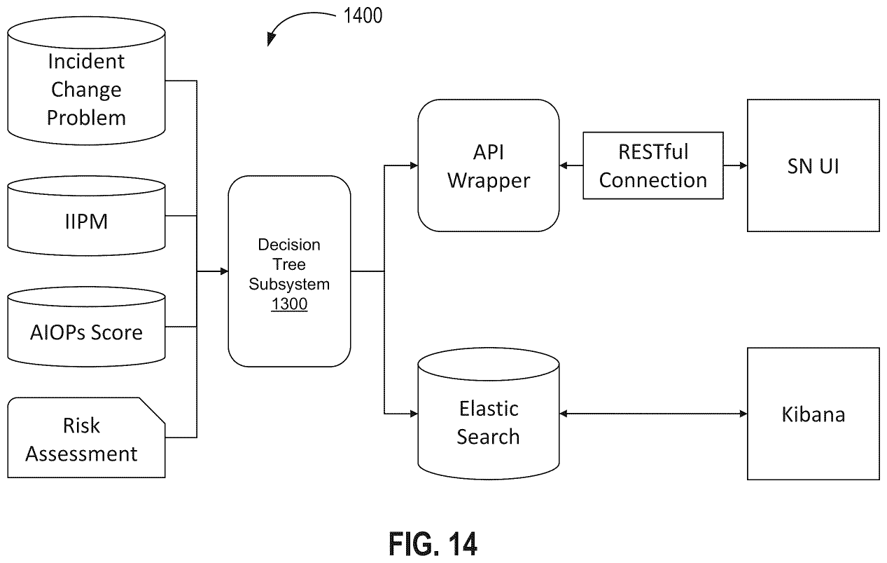

The decision tree subsystem 1300 may be interfaced with an API endpoint that takes incoming user request data as they go from New to Authorized state in ServiceNow™, and runs them through the decision tree 1350 to output the result. An example overview of the operating architecture 1400 for decision tree subsystem is shown in FIG. 14.

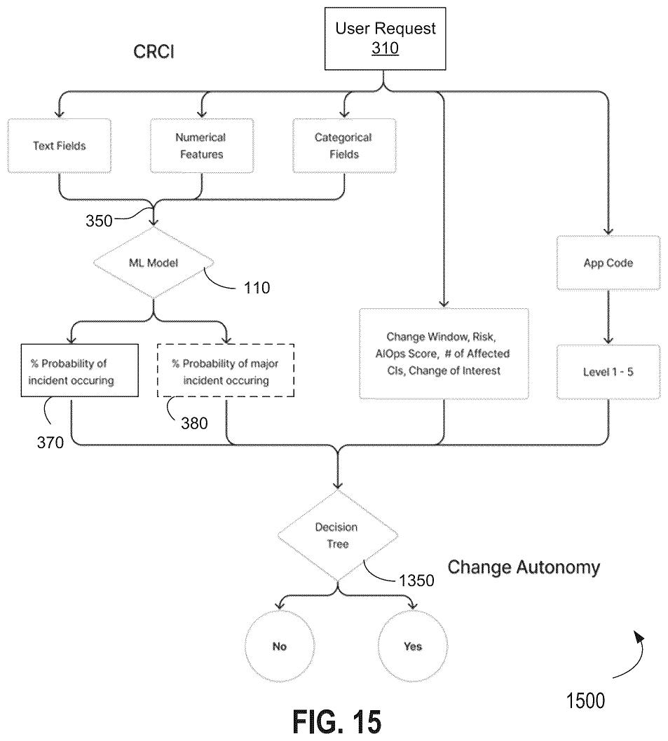

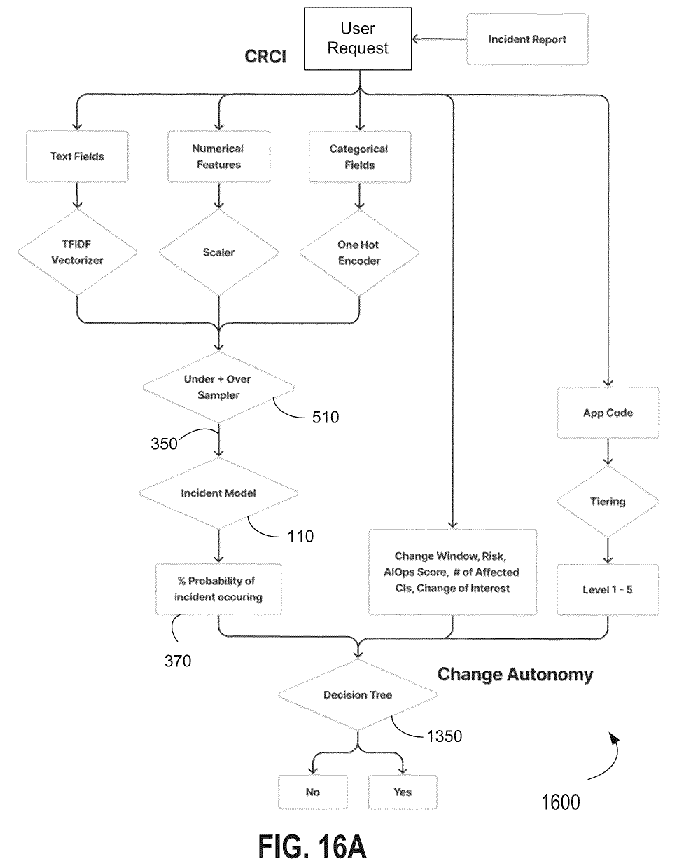

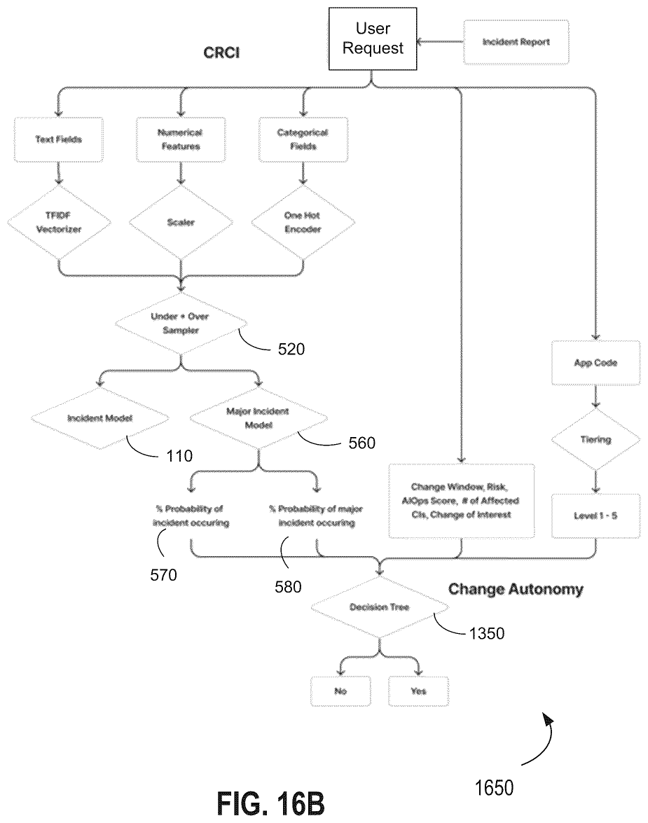

In some embodiments, as shown in FIGS. 15, 16A and 16B, system 100 may include both one or more machine learning models 110, 560 and decision tree subsystem 1300, and the integration of the two components may be configured via an user interface of system 100. In some embodiments, the one or more machine learning models 110, 560 and decision tree subsystem 1300 may be executed in parallel to generate their respective outputs.

FIG. 15 shows an example schematic block diagram 1500 for managing electronic resource access using both a trained machine learning model 110 and a decision tree subsystem including a decision tree component 1350, in accordance with some embodiments. In the diagram 1500, the user request 310 is processed by system 100 (e.g., by access manager 170) via feature engineering similar to that described above for FIGS. 5A to 5C, to generate feature matrix 250 for a trained machine learning model 110. ML Model 110 at inference time generates a probability output 370 based on feature matrix 350, the probability output 370 representing a probability of an incident occurrence as a result of granting user request 310. In some embodiments, ML Model 110 at inference time may optionally generate a second probability output 380 based on feature matrix 350, the probability output 380 representing a probability of a major incident occurrence as a result of granting user request 310.

In parallel, the user request 310 is processed to obtain user request data 1310, including the access or change window (planned start—planned end), risk of the access or change in the user request, the generated AIOps score, the number of configuration items affected by the user request, and whether the access or change is a change of interest. An app code level (e.g. from 1 to 5) from user request 310, along with the user request data 1310, and the output 370 (and optionally 380) are then used as input for the decision tree algorithm 1350, which processes a series of steps as described above in connection with FIG. 13, to determine if the user request 310 is safe to automate, generating a final result: yes or no.

For example, if the decision tree subsystem 1300 marks a user request as to be automatically approved (“autonomous”), output from one or more machine learning models 110, 560 may be used as a validation of the result from decision tree subsystem 1300. If the output from one or more machine learning models 110, 560 includes a probability value below a certain threshold, e.g., below a threshold of 50%, the access manager 170 may determine that the user request can be automatically approved (final output=True).

Not only does this increase the reliability of the decision tree subsystem 1300, the output from one or more machine learning models 110, 560 can be used further as an indicator of risky changes. For example, if the user request is marked as non-autonomous by the decision tree subsystem 1300 and the output from one or more machine learning models 110, 560 includes a probability value for causing an incident or major incident that is very high, this can be an indicator that this request requires special attention and a throughout review before it gets approved.

FIGS. 16A and 16B each shows an example schematic block diagram 1600, 1650 for training a machine learning model 110, 560 in connection with a decision tree structure, in accordance with some embodiments. During training, sampling step 510, 520 is implemented to correct imbalance in the training feature data, as described above.

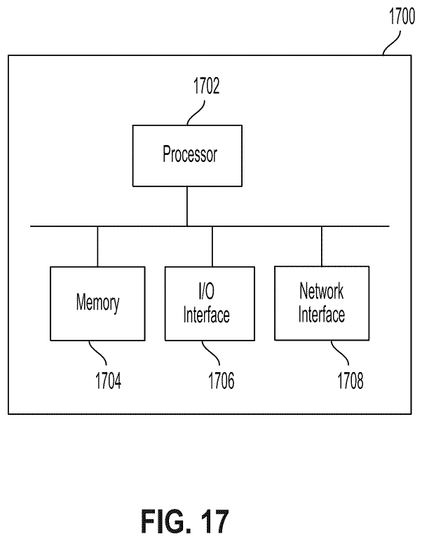

FIG. 17 is a schematic diagram of an example computing device 1700 that implements a system (e.g., one or more components of system 100), in accordance with an embodiment. As depicted, computing device 1700 includes one or more processors 1702, memory 1704, one or more I/O interfaces 1706, and one or more network interfaces 1708.

Each processor 1702 may be, for example, a microprocessor or microcontroller, a digital signal processing (DSP) processor, an integrated circuit, a field programmable gate array (FPGA), a reconfigurable processor, a programmable read-only memory (PROM), or any combination thereof.

Memory 1704 may include a suitable combination of any type of computer memory that is located either internally or externally such as, for example, random-access memory (RAM), read-only memory (ROM), compact disc read-only memory (CDROM), electro-optical memory, magneto-optical memory, erasable programmable read-only memory (EPROM), and electrically-erasable programmable read-only memory (EEPROM), Ferroelectric RAM (FRAM) or the like. Memory 1704 may store code executable at processor 1702, which causes training system to function in manners disclosed herein. Memory 1704 includes a data storage device or hardware. In some embodiments, the data storage device includes a secure datastore. In some embodiments, the data storage device stores received data sets, such as textual data, image data, or other types of data.

Each I/O interface 1706 enables computing device 1700 to interconnect with one or more input devices, such as a keyboard, mouse, camera, touch screen and a microphone, or with one or more output devices such as a display screen and a speaker.

Each network interface 1708 enables computing device 1700 to communicate with other components, to exchange data with other components, to access and connect to network resources, to serve applications, and perform other computing applications by connecting to a network such as network (or multiple networks) capable of carrying data including the Internet, Ethernet, plain old telephone service (POTS) line, public switch telephone network (PSTN), integrated services digital network (ISDN), digital subscriber line (DSL), coaxial cable, fiber optics, satellite, mobile, wireless (e.g. Wi-Fi, WiMAX), SS7 signaling network, fixed line, local area network, wide area network, and others, including any combination of these.

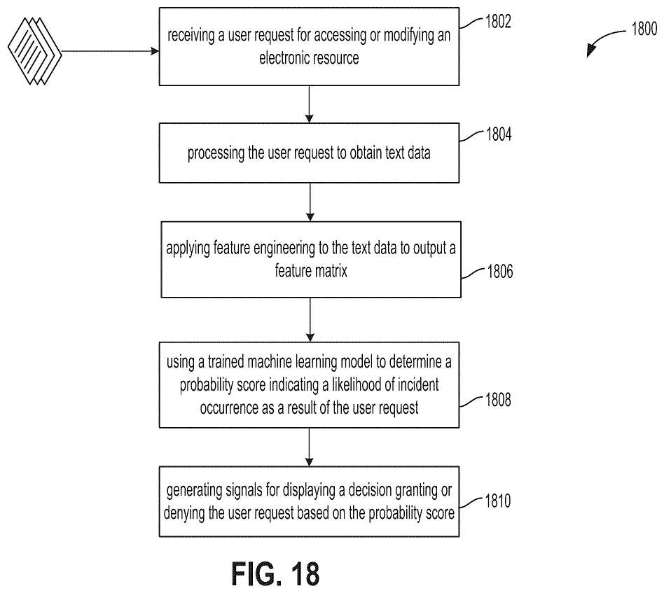

The methods and processes disclosed herein, including the process described below in view of FIG. 18, may be implemented using a system that includes multiple computing devices 1700. The computing devices 1700 may be the same or different types of devices.

Each computing devices may be connected in various ways including directly coupled, indirectly coupled via a network, and distributed over a wide geographic area and connected via a network (which may be referred to as “cloud computing”).

For example, and without limitation, each computing device 1700 may be a server, network appliance, set-top box, embedded device, computer expansion module, personal computer, laptop, personal data assistant, cellular telephone, smartphone device, UMPC tablets, video display terminal, gaming console, electronic reading device, and wireless hypermedia device or any other computing device capable of being configured to carry out the methods described herein.

FIG. 18 shows an example process 1800 performed by a system such as system 100 in FIG. 1, for managing electronic resources using machine learning, in accordance with some embodiments.

At operation 1802, system 100 can receive a user request for accessing or modifying an electronic resource.

At operation 1804, system 100 can process the user request to obtain text data.

At operation 1806, system 100 can apply feature engineering to the text data to output a feature matrix, the feature engineering may include, for example, application of natural language processing to the text data.

In some embodiments, system 100 can obtain one or more categorical fields and one or more numerical fields from the user request.

In some embodiments, system 100 can apply feature engineering to the data contained in the categorical fields and numerical fields to output the feature matrix.

In some embodiments, the natural language processing may include processing the text data using a Term Frequency—Inverse Document Frequency technique to generate a word matrix for one or more words in the text data, the matrix comprising one or more elements, with each element comprising an frequency score for a respective one of the one or more words.

At operation 1808, system 100 can use a trained machine learning model to determine a probability score indicating a likelihood of incident occurrence as a result of the user request.

In some embodiments, system 100 can use the trained machine learning model to determine a second probability score indicating a likelihood of major incident occurrence as a result of the user request; and generate signals for displaying a decision granting or denying the user request based on the second probability score.

In some embodiments, system 100 can: use the probability score from the trained machine learning model as input to a second trained machine learning model; execute the second trained machine learning model to determine a second probability score indicating a likelihood of major incident occurrence as a result of the user request; and generate signals for displaying a decision granting or denying the user request based on the second probability score.

In some embodiments, system 100 can: use the probability score from the trained machine learning model as input to a decision tree model; and execute the decision tree model to determine the decision granting or denying the user request based on the probability score.

At operation 1810, system 100 can generate signals for displaying a decision granting or denying the user request based on the probability score.

The embodiments of the devices, systems and methods described herein may be implemented in a combination of both hardware and software. These embodiments may be implemented on programmable computers, each computer including at least one processor, a data storage system (including volatile memory or non-volatile memory or other data storage elements or a combination thereof), and at least one communication interface.

Program code in instructions is applied to input data to perform the functions described herein and to generate output information. The output information is applied to one or more output devices. In some embodiments, the communication interface may be a network communication interface. In embodiments in which elements may be combined, the communication interface may be a software communication interface, such as those for inter-process communication. In still other embodiments, there may be a combination of communication interfaces implemented as hardware, software, and combination thereof.

Throughout the foregoing discussion, numerous references will be made regarding servers, services, interfaces, portals, platforms, or other systems formed from computing devices. It should be appreciated that the use of such terms is deemed to represent one or more computing devices having at least one processor configured to execute software instructions stored on a computer readable tangible, non-transitory medium. For example, a server can include one or more computers operating as a web server, database server, or other type of computer server in a manner to fulfill described roles, responsibilities, or functions.

The foregoing discussion provides many example embodiments. Although each embodiment represents a single combination of inventive elements, other examples may include all possible combinations of the disclosed elements. Thus if one embodiment comprises elements A, B, and C, and a second embodiment comprises elements B and D, other remaining combinations of A, B, C, or D, may also be used.

The term “connected” or “coupled to” may include both direct coupling (in which two elements that are coupled to each other contact each other) and indirect coupling (in which at least one additional element is located between the two elements).

The technical solution of embodiments may be in the form of a software product. The software product may be stored in a non-volatile or non-transitory storage medium, which can be a compact disk read-only memory (CD-ROM), a USB flash disk, or a removable hard disk. The software product includes a number of instructions that enable a computer device (personal computer, server, or network device) to execute the methods provided by the embodiments.

The embodiments described herein are implemented by physical computer hardware, including computing devices, servers, receivers, transmitters, processors, memory, displays, and networks. The embodiments described herein provide useful physical machines and particularly configured computer hardware arrangements. The embodiments described herein are directed to electronic machines and methods implemented by electronic machines adapted for processing and transforming electromagnetic signals which represent various types of information. The embodiments described herein pervasively and integrally relate to machines, and their uses; and the embodiments described herein have no meaning or practical applicability outside their use with computer hardware, machines, and various hardware components. Substituting the physical hardware particularly configured to implement various acts for non-physical hardware, using mental steps for example, may substantially affect the way the embodiments work. Such computer hardware limitations are clearly essential elements of the embodiments described herein, and they cannot be omitted or substituted for mental means without having a material effect on the operation and structure of the embodiments described herein. The computer hardware is essential to implement the various embodiments described herein and is not merely used to perform steps expeditiously and in an efficient manner.

The embodiments and examples described herein are illustrative and non-limiting. Practical implementation of the features may incorporate a combination of some or all of the aspects.

Although the embodiments have been described in detail, it should be understood that various changes, substitutions and alterations can be made herein without departing from the scope as defined by the appended claims.

Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed, that perform substantially the same function or achieve substantially the same result as the corresponding embodiments described herein may be utilized. Accordingly, the appended claims are intended to include within their scope such processes, machines, manufacture, compositions of matter, means, methods, or steps.

1. A computer system for managing electronic resource access, the computer system comprising:
a processor; and
a non-transitory memory storing one or more sets of instructions that when executed by the processor, causes the system to:
receive a user request for accessing or modifying an electronic resource;
process the user request to obtain text data;
apply feature engineering to the text data to output a feature matrix, the feature engineering comprising application of natural language processing to the text data;
use a trained machine learning model to determine a probability score indicating a likelihood of incident occurrence as a result of the user request; and
generate signals for displaying a decision granting or denying the user request based on the probability score.

2. The system of claim 1, wherein the instructions when executed by the processor further cause the system to: obtain one or more categorical fields and one or more numerical fields from the user request.

3. The system of claim 2, wherein the instructions when executed by the processor further cause the system to: apply feature engineering to the data contained in the categorical fields and numerical fields to output the feature matrix.

4. The system of claim 1, wherein the natural language processing comprises processing the text data using a Term Frequency—Inverse Document Frequency technique to generate a word matrix for one or more words in the text data, the matrix comprising one or more elements.

5. The system of claim 4, wherein each of the one or more elements comprises a respective frequency score for a respective word of the one or more words.

6. The system of claim 1, wherein the instructions when executed by the processor further cause the system to: use the trained machine learning model to determine a second probability score indicating a likelihood of major incident occurrence as a result of the user request; and generate signals for displaying a decision granting or denying the user request based on the second probability score.

7. The system of claim 6, wherein the major incident occurrence comprises an incident with one or more consequences meeting one or more predefined thresholds.

8. The system of claim 1, wherein the instructions when executed by the processor further cause the system to:
use the probability score from the trained machine learning model as input to a second trained machine learning model;
execute the second trained machine learning model to determine a second probability score indicating a likelihood of major incident occurrence as a result of the user request; and
generate signals for displaying a decision granting or denying the user request based on the second probability score.

9. The system of claim 1, wherein the instructions when executed by the processor further cause the system to:
use the probability score from the trained machine learning model as input to a decision tree model; and
execute the decision tree model to determine the decision granting or denying the user request based on the probability score.

10. A computer-implemented method for managing electronic resource access, the method comprising:
receiving a user request for accessing or modifying an electronic resource;
processing the user request to obtain text data;
applying feature engineering to the text data to output a feature matrix, the feature engineering comprising application of natural language processing to the text data;
using a trained machine learning model to determine a probability score indicating a likelihood of incident occurrence as a result of the user request; and
generating signals for displaying a decision granting or denying the user request based on the probability score.

11. The method of claim 10, comprising: obtaining one or more categorical fields and one or more numerical fields from the user request.

12. The method of claim 11, comprising: applying feature engineering to the data contained in the categorical fields and numerical fields to output the feature matrix.

13. The method of claim 10, wherein the natural language processing comprises processing the text data using a Term Frequency—Inverse Document Frequency technique to generate a word matrix for one or more words in the text data, the matrix comprising one or more elements.

14. The method of claim 13, wherein each of the one or more elements comprises a respective frequency score for a respective word of the one or more words.

15. The method of claim 10, comprising: using the trained machine learning model to determine a second probability score indicating a likelihood of major incident occurrence as a result of the user request; and generate signals for displaying a decision granting or denying the user request based on the second probability score.

16. The method of claim 15, wherein the major incident occurrence comprises an incident with one or more consequences meeting one or more predefined thresholds.

17. The method of claim 10, comprising:
using the probability score from the trained machine learning model as input to a second trained machine learning model;
executing the second trained machine learning model to determine a second probability score indicating a likelihood of major incident occurrence as a result of the user request; and
generating signals for displaying a decision granting or denying the user request based on the second probability score.

18. The method of claim 17, wherein the major incident occurrence comprises an incident with one or more consequences meeting one or more predefined thresholds.

19. The method of claim 10, comprising:
using the probability score from the trained machine learning model as input to a decision tree model; and
executing the decision tree model to determine the decision granting or denying the user request based on the probability score.

20. A non-transitory computer readable medium storing machine interpretable instructions, which when executed by a processor, cause the processor to perform:
receiving a user request for accessing or modifying an electronic resource;
processing the user request to obtain text data;
applying feature engineering to the text data to output a feature matrix, the feature engineering comprising application of natural language processing to the text data;
using a trained machine learning model to determine a probability score indicating a likelihood of incident occurrence as a result of the user request; and
generating signals for displaying a decision granting or denying the user request based on the probability score.
